(19) United States
(12) Patent Application Publication
(10) Pub. No.: US 2018/0365850 A1
(43) Pub. Date: Dec. 20, 2018

(54) ONLINE BODY SIZE MEASUREMENT SYSTEM

(71) Applicant: SHEN ZHEN FASHION THCH CO., LTD, Guangdong (CN)

(72) Inventor: Yanping XU, Guangdong (CN)

(21) Appl. No.: 16/060,957

(22) PCT Filed: May 31, 2017
(86) PCT No.: PCT/CN2017/086514

§ 371 Date: Jun. 11, 2018

(30) Foreign Application Priority Data
Oct. 26, 2016 (CN) 201610944675.0

(51) Int. Cl. G06T 7/62; G01B 21/02

(52) U.S. Cl. CPC G06T 7/62; G01B 21/02

(57) ABSTRACT

Provided is an online body size measurement system, comprising a user information upload module (1), an image processing module (2), a management module (4) and a data storage module (3). The user information upload module (1) uploads the user information containing image information and height information to the image processing module (2). The image processing module (2) performs tracing on the image information and matches the traced 3D lattice information with the height information, so as to generate user size information, the user size information being stored in the data storage module (3) connected to the management module (4), and the user size information containing a unique secret order for identifying the user. The system captures a human body image and combines with a human body size calculation formula, so that the specific size of the human body can be easily and conveniently known, which is convenient for customizing comfortable clothing, avoiding the user selecting from a large quantity of clothing, saving time cost for the user and improving the user experience of the customized clothing.

### BACKGROUND OF THE INVENTION

The invention relates to online measurement technology field, in particular to a kind of online body measurement system.

As life pace becomes faster, more and more office workers have no time to purchase well-fitting dresses in physical stores, instead, they choose online shopping that only relies on the specific size of human body as a reference. In actual online shopping, most of returns have resulted from ill-fitting dresses in size, therefore, it is of practical significance to improve the efficiency and quality of online measurement in order to customize comfortable clothes for consumers.

### BRIEF SUMMARY OF THE INVENTION

The purpose of the present invention is to overcome the deficiencies in prior art and provide a kind of online body measurement system. By capturing body image and combining with calculation formulas of body size, it could conveniently get specific body size, so as to customize comfortable garments, thus avoiding selection from a large number of clothes by user, greatly saving consumers' time cost and improving user experience in term of customized clothes.

In order to solve the above technical problems, an embodiment of the present invention provides an online body measurement system. The improvement thereof includes an user information upload module for uploading user information containing image information and height-weight information to an image processing module. The image processing module plots points based on the image information and matches the plotted three-dimensional lattice information with the height information and then generates user measurements information. The user measurements information is stored in data storage module connected with management module and also included with a unique secret order for identifying the user.

The management module includes a verification unit and an inquiry unit for verifying user right. The user right includes administrator right and ordinary right. When the verification unit detects that the user belongs to an ordinary right, the inquiry unit calls out user measurements corresponding to the unique secret order stored in the data storage module in advance after matching. When the verification unit detects that the user belongs to an administrator right, the inquiry unit performs global search for the data storage module by the user information.

The user information upload module is further connected with the record module storing the latest operation information of the user in cache and generating operation information table containing the unique secret order. Of course, it could be understood that the record module records user's history operation information according to actual needs, so as to directly call out each history operation information, simplifying the system operation. The image processing module directly calls out the operation information table for secondary processing on the user information.

The secondary processing on the user information includes acquisition of operation instruction from the operation information table through a unique secret order, calling up user information corresponding to the operation instruction from the data storage module and processing.

The embodiments of the present invention have the following beneficial effects:

In embodiments of the present invention, the online body measurement system can capture body images and combine with calculation formulas of body size in order to conveniently obtain specific size of the human body for customizing comfortable garments, thereby avoiding selection from a large number of clothes by users, greatly saving the user's time cost and improving the user experience about customized clothes.

### BRIEF DESCRIPTION OF THE DRAWINGS

FIG. 1 is a structural diagram of the online body measurement system in the present invention.

### DETAILED DESCRIPTION OF THE INVENTION

The further description for the present invention is showed as follows with reference to the accompanying drawings and specific embodiments:

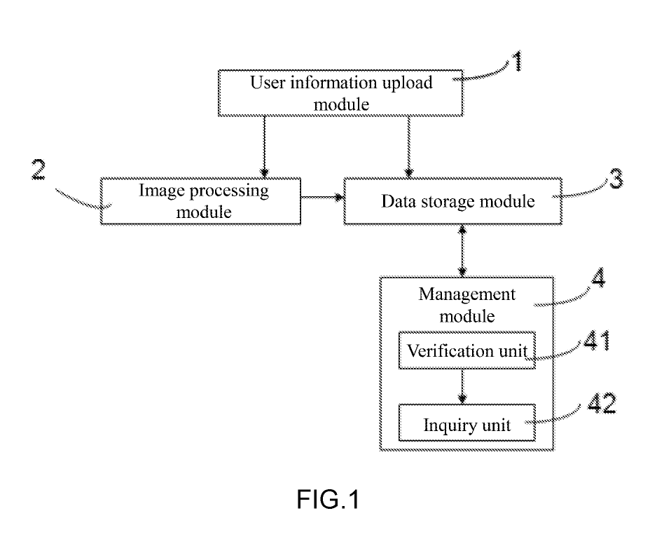

As shown in FIG. 1, the present invention discloses an online body measurement system including an user information upload module 1 for uploading user information including image information and height information to an image processing module 2, and the image processing module 2 plots points for the image information and matches the plotted three-dimensional lattice information with the height information to generate the user measurements information that is stored in the data storage module 3 being connected to the management module 4 and included with an unique secret order for identifying user. It is understandable that the process for obtaining three-dimensional lattice information with point depiction may click right mouse button on position corresponding to image information uploaded by user, and record the point's coordinates by the system, and finally generate three-dimensional lattice information through coordinates of multiple measurement points, correspondingly determine measurement value corresponding to the three-dimensional lattice information according to height information, i.e. body measurements.

Further, the management module 4 includes a verification unit 41 and an inquiry unit 42 for verifying user right. The user right includes administrator right and ordinary right. When the verification unit 41 detects that the user belongs to ordinary right, the inquiry unit 42 calls out use measurements corresponding to the unique secret order stored in the data storage module 3 in advance after matching. When the verification unit 41 detects that the user belongs to administrator right, the inquiry unit 42 performs global search for the data storage module by the user information, wherein the data uploaded from external system via user interface is one-way flow in order to eliminate risk of user data outflow. The administrator can perform user data relevant operation by login certification in order to ensure risk controllability of user data.

Further, the user information upload module 1 is also connected with the record module storing the latest operation information of user in cache and generating an operation information table containing a unique secret order. The image processing module 2 directly calls out the operation information table to perform secondary processing on the user information. Of course, it could be understood that the record module records user's history operation information according to actual needs, so as to directly call out each history operation information, simplifying the system operation.

Moreover, the secondary processing on the user information includes acquisition of operation instruction from the operation information table through a unique secret order; calling up user information corresponding to the operation instruction from the data storage module 3 and processing.

What has been described above is only a preferred embodiment of the present invention, and the above specific embodiments are not limitations of the present invention. In the technical scope of the invention, all kinds of deformation and modification can be made, by which all embellishing, modification or equivalent substitution made by ordinary technicians in the field belong to the scope of protection of this invention.

What is claimed is:

1. A kind of online body measurement system is characterized by comprising an user information upload module, an image processing module, a management module and a data storage module, wherein the user information upload module uploads user information including image information and height-weight information to an image processing module, and the image processing module plots points for the image information and matches the plotted three-dimensional lattice information with the height information and then generates user measurements information. The user measurements information is stored in data storage module connected with management module and also included with a unique secret order for identifying the user.

2. A kind of online body measurement system of claim 1 is characterized in that the management module includes a verification unit and an inquiry unit for verifying user right. The user right includes administrator right and ordinary right. When the verification unit detects that the user belongs to an ordinary right, the inquiry unit calls out user measurements corresponding to the unique secret order stored in the data storage module in advance after matching. When the verification unit detects that the user belongs to an administrator right, the inquiry unit performs global search for the data storage module by the user information.

3. A kind of online body measurement system of claim 1 is characterized in that the user information upload module is further connected with the record module storing the latest operation information of the user in cache and generating operation information table containing the unique secret order.

4. A kind of online body measurement system of claim 3 is characterized in that the image processing module directly calls out the operation information table for secondary processing on the user information.

5. A kind of online body measurement system of claim 4 is characterized in that the secondary processing on the user information includes acquisition of operation instruction from the operation information table through a unique secret order; calling up user information corresponding to the operation instruction from the data storage module and processing.
